(19) United States
(12) Patent Application Publication
(10) Pub. No.: US 2018/0020229 A1
(43) Pub. Date: Jan. 18, 2018

(54) COMPUTATIONALLY EFFICIENT MOTION COMPENSATED FRAME RATE CONVERSION SYSTEM

(71) Applicant: Sharp Laboratories of America, Inc., Camas, WA (US)

(72) Inventors: Xu CHEN, Cary, NC (US); Petrus J.L. VAN BEEK, Vancouver, WA (US); Christopher A. SEGALL, Vancouver, WA (US)

(21) Appl. No.: 15/210,659

(22) Filed: Jul. 14, 2016

(51) Int. Cl. H04N 19/51; H04N 19/176; H04N 19/172

(52) U.S. Cl. CPC H04N 19/51; H04N 19/172; H04N 19/176

(57) ABSTRACT

A system for frame rate conversion of a video.

### CROSS-REFERENCE TO RELATED APPLICATIONS

None.

### BACKGROUND OF THE INVENTION

The present invention relates to frame rate conversion.

For a digital video system, the video is encoded and decoded using a series of video frames. Frames of a video are captured or otherwise provided at a first frame rate, typically a relatively low frame rate (e.g., 24 Hz or 30 Hz). A video presentation device often supports presenting the video at a second frame rate, typically a relatively high frame rate (e.g., 60 Hz or 120 Hz). With the difference in the frame rates, the video frame rate is modified from the first frame rate to the second frame rate using a frame rate up conversion process. Frame rate conversion may be used to match the frame rate of the video to the display refresh rate which tends to reduce video artifacts, such as motion judder. In addition, frame rate conversion also tends to reduce motion blur on liquid crystal displays due to the hold-type nature of liquid crystal displays.

Frame rate up conversion techniques may create interpolated frames using received frames as references or may create new frames using frame repetition. The new video frames that are generated may be in addition to or in place of the frames of the input video, where the new frames may be rendered at time instances the same as and/or different from the time instances that the input frames are rendered. The frame interpolation may be based upon using a variety of different techniques, such as using a frame interpolation technique based on motion vectors of the received frames, such that moving objects within the interpolated frame may be correctly positioned. Typically, the motion compensation is carried out on a block by block basis. While the traditional motion compensated frame rate up conversion process provides some benefits, it also tends to be computationally expensive. Conventional block-by-block motion vector estimation methods do not consider which aspects of the moving image are salient and relevant to achieving high image quality frame interpolation.

Liquid crystal displays have inherent characteristics that tend to result in significant motion blur for moving images if not suitably controlled. The motion blur often tends to be exasperated as a result of the frame rate conversion process. To reduce or otherwise not exasperate the motion blur tends to require particularized frame rate conversion techniques. In addition, depending on the frame rate conversion technique motion judder may result that is readily perceivable by the viewer.

Accordingly, there is a need for an effective frame rate conversion system in a manner that maintains sufficiently high quality while being performed in a manner to reduce the implementation complexity and associated expense.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a frame rate conversion technique including both motion estimation and motion compensation at a reduced resolution.

FIG. 2 illustrates a frame rate conversion technique including reduced resolution frame rate conversion without additional processing.

FIG. 3 illustrates a frame rate conversion technique including reduced resolution frame rate up conversion using additional high frequency information from an adjacent input frame.

FIG. 4 illustrates a frame rate conversion technique including reduced resolution conversion using additional high frequency information from an adjacent frame including adaptively and suppressing moving edges.

FIG. 5 illustrates a frame rate conversion technique including reduced resolution frame rate conversion including adding additional weighted adjacent input frame adaptively and suppressing moving edges.

FIG. 6 illustrates a technique for adaptively adding high frequency information while suppressing moving edges.

FIG. 7 illustrates a frame rate conversion technique including reduced resolution frame rate conversion including adding high frequency information from an adjacent input frame while applying enhancement of the moving edges.

FIG. 8 illustrates another technique for adaptively adding high frequency information while suppressing moving edges using a LTI enhancement.

FIG. 9 illustrates another technique for adaptively adding high frequency information.

### DETAILED DESCRIPTION OF PREFERRED EMBODIMENT

Frame rate conversion generally consists of two parts, namely, motion estimation and motion compensated frame interpolation. The most computationally expensive and resource intensive operation tends to be the motion estimation. For example, motion estimation may be performed by using block matching or optical flow based techniques. A block matching technique involves dividing the current frame of a video into blocks, and comparing each block with multiple candidate blocks in a nearby frame of the video to find the best matching block. Selecting the appropriate motion vector may be based upon different error measures, such as a sum of absolute differences, and a search technique, such as for example 3D recursive searching.

Improved search techniques in block matching may be used to reduce the time required for matching. However with increasingly greater resolutions, such as 4K and 8K video resolutions, the computational complexity (e.g., the time necessary for matching) increases substantially. Also, with increasingly greater resolutions, such as 4K and 8K video resolutions, the line buffers together with the memory required for motion estimation and motion compensation is typically proportional to the resolution of the video frame, increasing the cost and computational complexity. Rather than developing increasingly sophisticated block matching techniques for frame rate conversion, it is desirable to use a computationally efficient motion compensation scheme relying on an improved scaling technique that maintains high frequency information while suppressing artifacts in the high frequency information.

In many implementations the computational expense may be reduced by performing the motion estimation based upon down-sampled image content. However, the motion compensation and/or motion compensated interpolation is typically performed at the original resolution which still incurs high computational complexity.

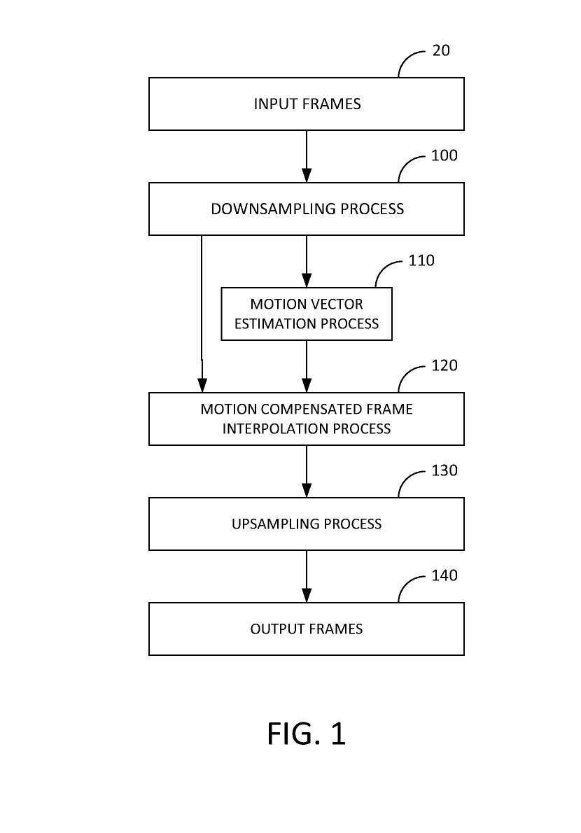

Referring to FIG. 1, an overview of a framework for frame rate conversion based upon a resolution reduction is illustrated. A series of input frames 20, such as frames suitable for an 8K display, are provided to a downsampling process 100. The downsampling process 100 reduces the resolution of each of the input frames 20. For example, the downsampling process 100 preferably downsamples the input frames 20 by a factor of 4. The downsampling process 100 may use any suitable technique, such as bilinear interpolation. The downsampling process 100 may use any suitable factor, such as 2, 4, 6, 8. The downsampling process 100 provides the downsampled input frames 20 to a motion vector estimation process 110 which estimates the motion vectors between different portions, such as blocks, of the input frames. Any suitable technique may be used to estimate the motion vectors. The motion vectors from the motion vector estimation process 110 may be provided to a motion compensated frame interpolation process 120 which uses the downsampled input frames 20 from the downsampling process 100 in combination with the motion vectors from the motion vector estimation process 110 to determine motion compensated interpolated frames. The motion compensated interpolated frames from the motion compensated frame interpolation process 120 may be provided to an upsampling process 130. The upsampling process 130 increases the resolution of each of the motion compensated interpolated frames. For example, the upsampling process 130 preferably upsamples the motion compensated interpolated frames by a factor of 4. The upsampling process 130 may use any suitable factor, such as 2, 4, 6, 8, and preferably the same factor as the downsampling process 100. The upsampling process may use any suitable technique, such as bilinear interpolation, and preferably the technique is matched to the technique used in the downsampling process 100. The upsampling process 130 provides the output frames 140.

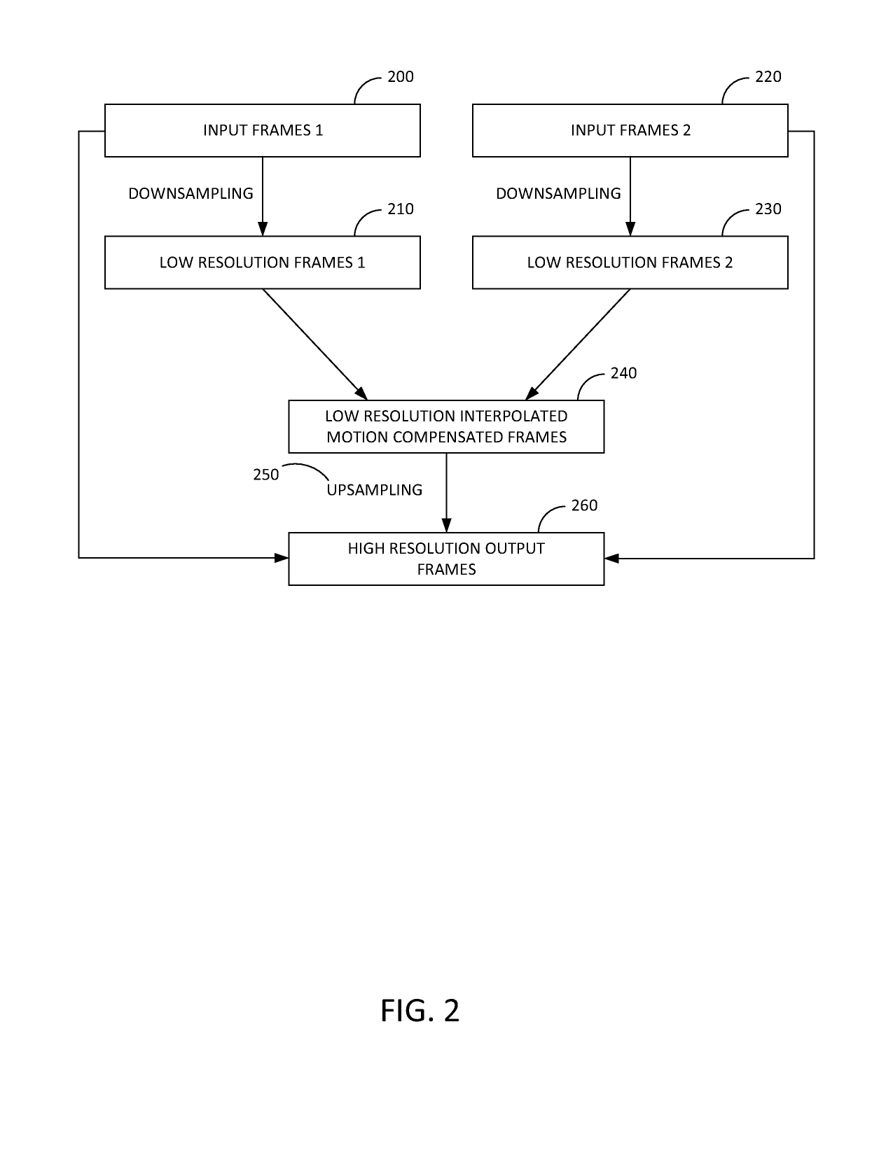

Referring to FIG. 2, an exemplary detailed overview of the framework for frame rate conversion of FIG. 1 is illustrated. A series of input frames 1 200, such as frames suitable for an 8K display, are downsampled to determine a series of low resolution frames 1 210. A series of input frames 2 220, such as frames suitable for an 8K display, are downsampled to determine a series of low resolution frames 2 230. One or more of the frames 1 and one or more of the frames 2 are used to determine the motion vectors and then determine interpolated motion compensated frames 240. Motion compensated interpolation may use any suitable technique or combination of techniques to generate temporally interpolated frames, which may include a linear or non-linear combination of pixels from adjacent frames 1 and frames 2, or based on frames 1 only, or based on frames 2 only. Frame rate conversion may include a variety of adaptive or non-adaptive processing steps, including motion-compensated interpolation, non-motion-compensated interpolation, frame repetition, adaptive selection of pixel interpolation and repetition, linear and nonlinear filtering, and other techniques. Any technique may be used, as desired. The interpolated motion compensated frames are determined based upon the low resolution input frames. The computational cost of the frame rate conversion process at the lower resolution is significantly lower than the computational cost at the higher resolution. The interpolated motion compensated frames 240 are upsampled 250 to provide high resolution output frames 260. In general high resolution output frames 260 may include the input frames 1 and/or input frames 2, if desired. Unfortunately, the interpolated motion compensated frames tend to be substantially blurry because they are generated at a low resolution and then subsequently upscaled to a higher resolution. At least in part, the blurry frames are a result of the absence of a significant part of the high resolution content that was contained within the corresponding input frames 1 and input frames 2, prior to being downsampled. By way of example, often blurred edges will result and large area backgrounds will tend to flicker as a result of the loss of the high frequency information in the interpolated frames relative to input frames that are not interpolated.

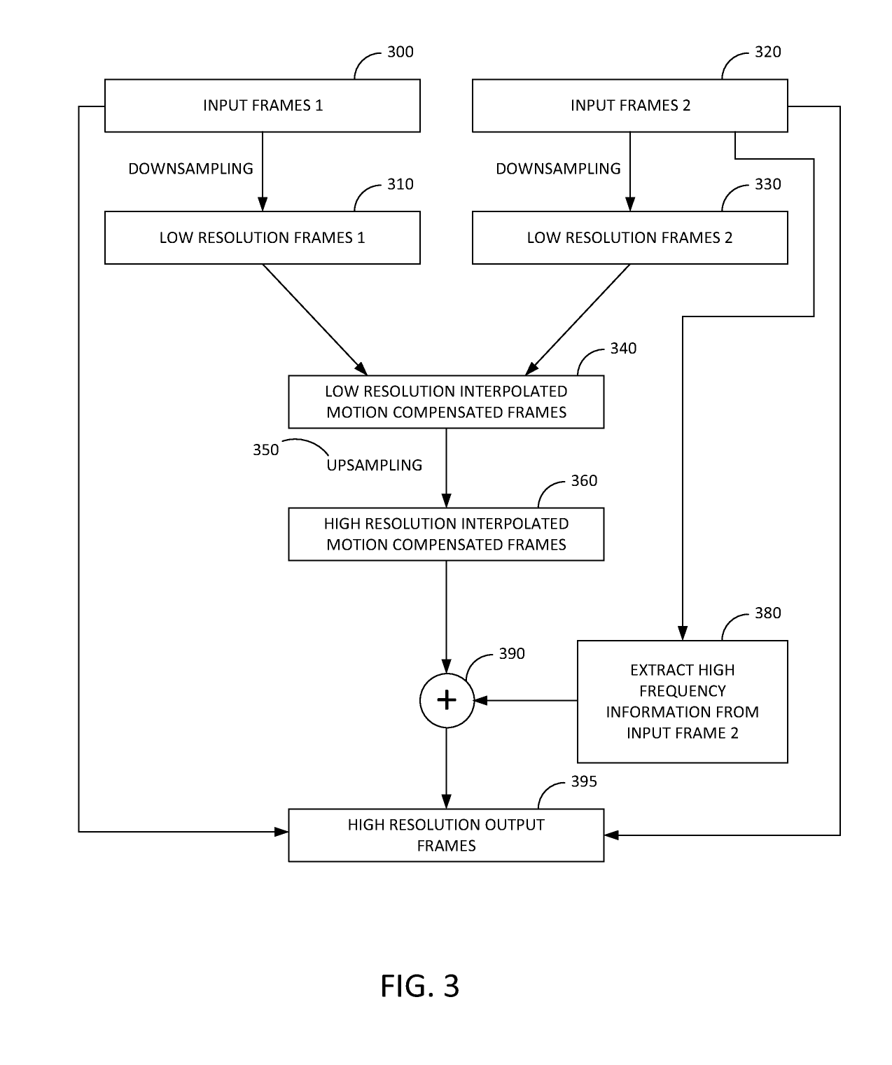

In order to enhance the quality of the interpolated frames, and in particular to reduce the blurry aspects of the image, a suitable technique may be used to reduce the loss of high frequency information contained in the input frames. Referring to FIG. 3, one technique to reduce the loss of high frequency information is to extract high frequency information from an input frame 2, which is preferably the next adjacent frame to a corresponding input frame 1 of a video sequence. The extracted high frequency information from the input frame 2 may be included back into the high resolution interpolated motion compensated frame in any suitable manner, to provide a high resolution output frame with additional high frequency information.

One exemplary technique of a framework for frame rate conversion including adding back high frequency information into a high resolution interpolated motion compensated frame is illustrated in FIG. 3. A series of input frames 1 300, such as frames suitable for an 8K display, are downsampled to determine a series of low resolution frames 1 310. A series of input frames 2 320, such as frames suitable for an 8K display, are downsampled to determine a series of low resolution frames 2 330. One or more of the frames 1 and one or more of the frames 2 are used to determine the motion vectors and then determine interpolated motion compensated frames 340. The interpolated motion compensated frames are determined based upon the low resolution input frames. The interpolated motion compensated frames 340 are upsampled 350 to provide high resolution interpolated motion compensated frames 360. High frequency information is extracted 380 from the input frames 2 320. One technique for extracting high frequency information from the input frames 2 320 is to downsample and then upsample a corresponding one of the input frames 2 320 by a factor, such as 4, and determine the difference between the frames (e.g., ΔF₂=F₂−\tilde{F}₂, where F₂ is the original frame and \tilde{F}₂ is the frame resulting from downsample and upsampling). Another technique to determine \tilde{F}₂ is to applying a smoothing filter to F₂ . Another technique to determine the high frequency information ΔF₂ is to filter F₂ directly using a high pass or band-pass filter. The extracted high frequency information from input frames 2 380 may be combined 390 with the high resolution interpolated motion compensated frames 360 to provide high resolution output frames 395. By way of example, the combining 390 may be a summation process (e.g., [symbol] _{H}=F_{H}+ΔF₂, where F_{H} is the high resolution interpolated motion compensated frame). In general high resolution output frames 395 may include the input frames 1 and/or input frames 2, if desired.

The framework illustrated in FIG. 3 incorporates reduced resolution process and adding high frequency information from F₂ which results in an improved sharpness in both of the foreground and the background together with reduced large area flickering. However, due to motion within the images, artifacts that include ghost edges near strong moving edges are also present. In general the ghost edges result in a break up or duplication of the edge portions of the images. The artifacts of ghost edges may be the result of incorporating high frequency information from the input frame F₂ to the interpolated frame F_{H} without motion compensation. The interpolated frame is rendered at a different point in time compared to the input frame; hence, some of the high frequency detail may be displaced due to motion.

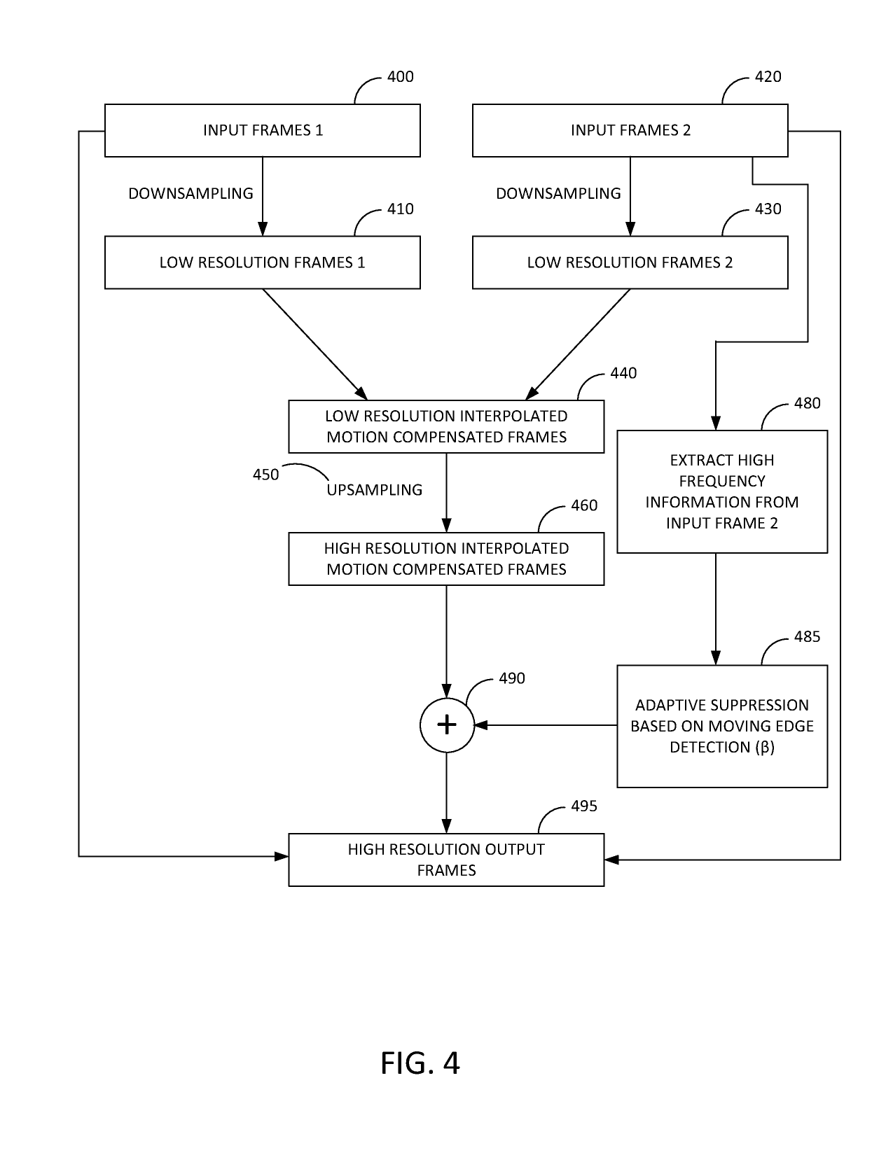

One exemplary technique of a framework for frame rate conversion including adding back high frequency information into a high resolution interpolated motion compensated frame, together with modification of the high frequency information that suppresses the strong moving edges, is illustrated in FIG. 4. A series of input frames 1 400, such as frames suitable for an 8K display, are downsampled to determine a series of low resolution frames 1 410. A series of input frames 2 420, such as frames suitable for an 8K display, are downsampled to determine a series of low resolution frames 2 430. One or more of the frames 1 and one or more of the frames 2 are used to determine the motion vectors and then determine interpolated motion compensated frames 440. The interpolated motion compensated frames are determined based upon the low resolution input frames. The interpolated motion compensated frames 440 are upsampled 450 to provide high resolution interpolated motion compensated frames 460. High frequency information is extracted 480 from the input frames 2 420. One technique for extracting high frequency information from the input frames 2 420 is to downsample and then upsample a corresponding one of the input frames 2 420 by a factor, such as 4, and determine the difference between the frames (e.g., ΔF₂=₂−\tilde{F}₂, where F₂ is the original frame and \tilde{F}₂ is the frame resulting from downsample and upsampling). Another technique to determine \tilde{F}₂ is to applying a smoothing filter to F₂. Another technique to determine the high frequency information ΔF₂ is to filter F₂ directly using a high pass or band-pass filter. The extracted high frequency information from input frames 2 480 may be modified by adaptively adding high frequency information and suppressing the moving strong edges. Suppression of moving strong edges may include an edge detection step or edge strength filter step. The edge detection or edge strength filter step may use any suitable technique, such as for example, a Sobel technique, a Prewitt technique, a Roberts technique, a differential technique, a morphological technique, or any other edge detector technique. An adaptive factor is determined based on the measurement of moving edge strength. The adaptive factor may be a spatially varying factor β which is equivalent to a weight map that controls to what extent the high frequency information should be added to the interpolated and upscaled frame. The weight map is determined in a locally adaptive manner and may have a different weight at each pixel. The interpolated output frame can be represented as: [symbol] _{H}=F_{H}+β*ΔF₂. The output of the adaptive suppression based on moving edge detection 485 may be combined 490 with the high resolution interpolated motion compensated frames 460 to provide high resolution output frames 495. In general high resolution output frames 495 may include the input frames 1 and/or input frames 2, if desired.

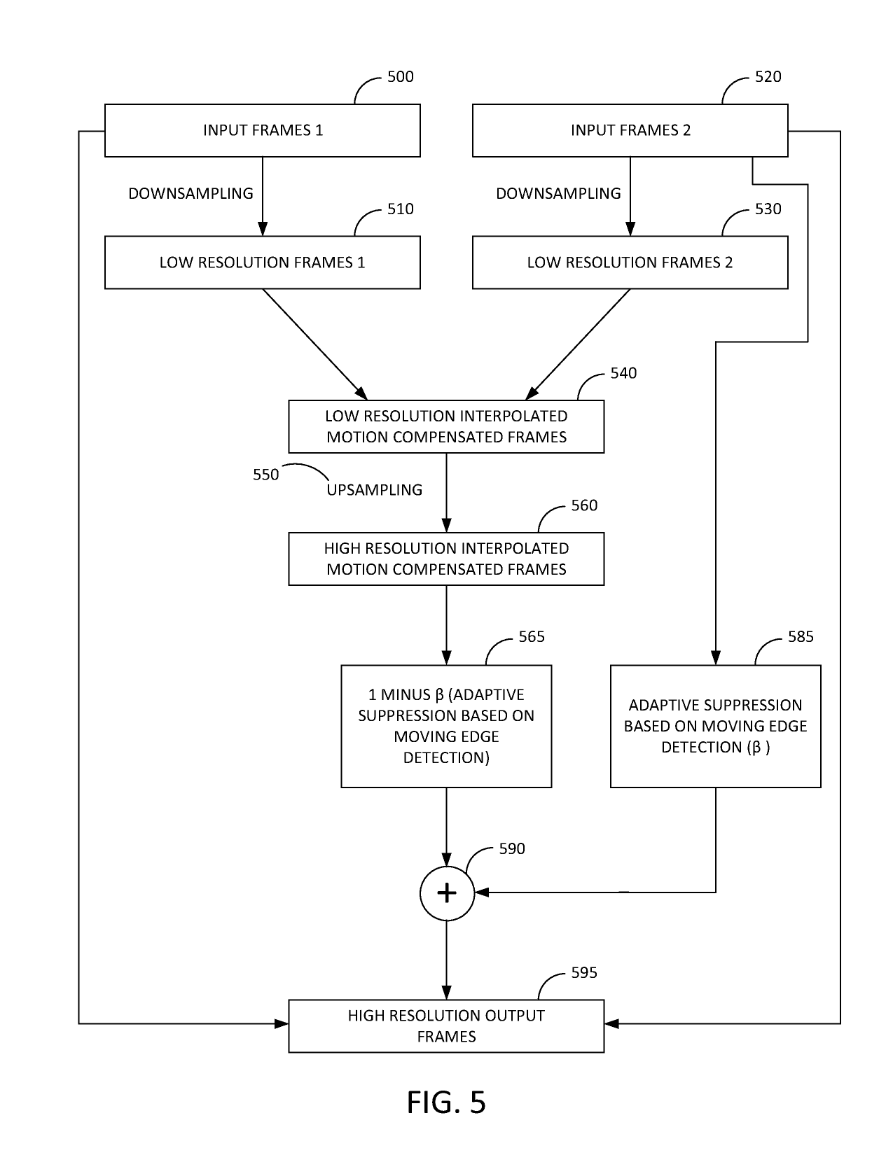

Alternatively, the system may also generate the interpolated frame by computing a weighted sum of the interpolated frame before adding high frequency information and the next input frame F₂ as: [symbol] _{H}=(1=β)*F_{H}+β*F₂, as illustrated in FIG. 5. A series of input frames 1 500, such as frames suitable for an 8K display, are downsampled to determine a series of low resolution frames 1 510. A series of input frames 2 520, such as frames suitable for an 8K display, are downsampled to determine a series of low resolution frames 2 530. One or more of the frames 1 and one or more of the frames 2 are used to determine the motion vectors and then determine interpolated motion compensated frames 540. The interpolated motion compensated frames are determined based upon the low resolution input frames. The interpolated motion compensated frames 540 are upsampled 550 to provide high resolution interpolated motion compensated frames 560. The low resolution frames 2 530 may be modified by adaptively adding high frequency information (if desired) and suppressing the moving strong edges 585. The adaptive factor may be a β which is a weight map that controls to what extent the high frequency information should be added to the interpolated and upscaled frame. The weight map is determined in a locally adaptive manner and may have a different weight at each pixel. The high resolution interpolated motion compensated frames 560 may be modified by 1−β 565 to offset, at least in part, the adaptive suppression based on moving edge detection 585 which may be summed together 590. The interpolated output frame can be represented as: [symbol] _{H}=(1−β)*F_{H}+β*F₂. The output of the adaptive suppression based on moving edge detection 585 may be combined 590 with the 1 minus β 565 to provide high resolution output frames 595. In general high resolution output frames 595 may include the input frames 1 and/or input frames 2, if desired.

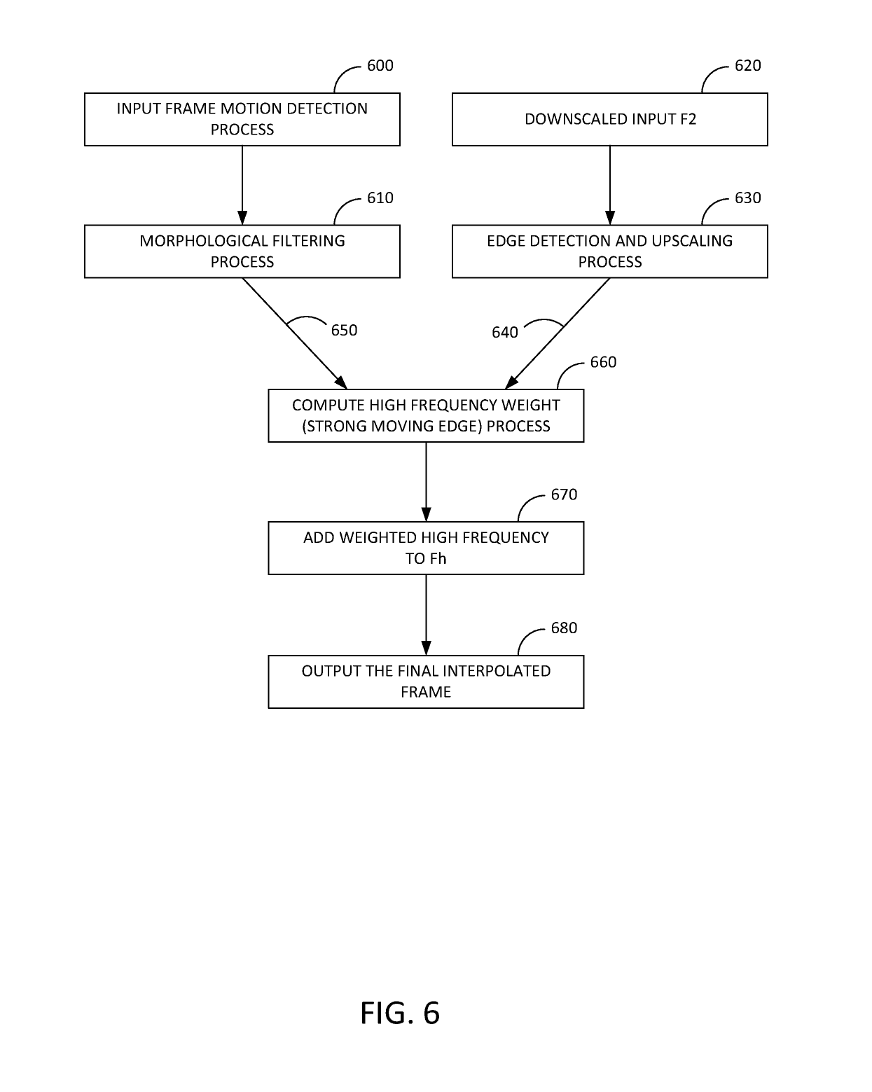

One exemplary technique for adaptive adding high frequency information and suppressing moving strong edges is illustrated in FIG. 6. A motion detection process 600 between two adjacent input frames may be determined using any suitable technique, such as pixel differencing, to determine a difference map. Based on the resulting difference map a thresholding process may be applied to determine a binary map. For example, a threshold of ten may be used to determine the binary map. Instead of a thresholding process, a soft-clipping process may be used, resulting in a non-binary map. The map from the input frame pixel absolute differencing and thresholding or soft-clipping process 600 may be further modified using a morphological filtering process 610 to refine the shape of the motion blobs and remove outliers. The resulting motion detection map 650 indicates areas in the frame with significant motion. Also, the technique may use any edge detection and upscaling process on a suitable input frame, such as an edge detection process and subsequent upscaling 630 using a low resolution adjacent input frame F₂ 620. For example, a Canny edge detection may be applied using a 0.2 threshold for Canny edge detection. Performing the edge detection using the low resolution frame reduces the computational complexity of the system and the noise associated with the edges are less in the lower resolution image. In addition, high resolution textures are excluded from the moving edge detection map. Accordingly, smaller texture details which tend to be high in frequency tend to be included in the final interpolated frame, while the more significant moving edges tend to be suppressed. The edge map may be upsampled by the same factor as the input frame was downsampled, such by a factor of 4. The edge map 640 from the edge detection and upscaling process 630 and the motion detection map 650 from the morphological filtering process 610 preferably both have the same resolution.

One technique to identify moving edges, is for each pixel of the edge map 640 identified as an edge to compare it with a corresponding pixel of the motion detection map 650 to determine if it is a moving edge, thus employing a compute high frequency weight process 660. If both an edge is determined from the edge map and that edge is determined to be moving from the motion detection map, then the system may identify such a pixel as a moving edge and reduce adding additional weighting to the high frequency content. For those pixels identified as a moving edge, the high frequency information from the adjacent input frame is preferably not added into the corresponding pixel to reduce visibility of ghost edges. If either an edge is not determined from the edge map or that the edge is not determined to be moving from the motion detection map, then the system may not identify such a pixel as a moving edge and add weighted high frequency information 670. For those pixels not identified as a moving edge, the high frequency information from the adjacent input frame is added into the corresponding pixel. As a result of adding the high frequency information 670, an output of the final interpolated frame 680 is provided.

Preferably, the high frequency information is stored in memory while the low resolution information is processed. For example, performing motion estimation on the low resolution information typically requires pixel data that appears later in the frame than the pixel corresponding to a motion vector being currently calculated. This may include the storage of the high frequency information so that it is available after the motion vector is computed. Furthermore, the dynamic range of the high frequency information is typically larger than the original image, and so the required storage space may need to be increased more than otherwise would be necessary.

To reduce the amount of memory storage necessary, in one example, the high frequency information is stored with reduced precision and/or reduced resolution, and this reduced precision and/or reduced resolution version is converted back to full precision and full resolution high frequency information for the determination of \hat{F}_{H}. In an example, a reduced precision version of the high frequency information may be determined by differential coding of the high frequency information. In an example, a low resolution version of the high frequency information may be determined by decimating the high frequency information. In an example, a reduced precision version of the high frequency information may be determined by quantizing the high frequency information. In an example, a reduced precision and/or reduced resolution version of the high frequency data may be determined by a combination of differential coding, decimation, quantization, and/or another suitable technique.

When the high resolution information is stored at lower precision and/or lower resolution, the final interpolated frame may be determined for example as one of:

\hat{F}_{H}=F_{H}+UpDown(ΔF₂))

\hat{F}_{H}=F_{H}+β*UpDown(ΔF₂))

\hat{F}_{H}=(1−β)F_{H}+β*UpDown(ΔF₂))

where Down( ) denotes conversion of the high resolution information to a reduced precision and/or reduced resolution representation and Up( ) denotes conversion of a reduced precision and/or reduced resolution high frequency representation to high frequency information. For example, the Up( ) operation is the inverse of the Down( ) operation so that Up(Down(F)) is equal to F. For example the combination of the Up( ) operation and Down( ) operation is a so called lossy operation, so that Up(Down(F)) is similar to F but may not be mathematically equal to F. For example, the reduced precision and/or reduced resolution high frequency version has the same spatial resolution as the low resolution image. For example, the reduced precision and/or reduced resolution high frequency version has a spatial resolution that is different from the spatial resolution of the low resolution image and different from the spatial resolution of the high frequency information.

While aforementioned technique with adaptively adding high frequency information achieves significant improvements in terms of picture quality, such techniques tend not to have sufficiently sharp moving edges in the interpolated frame which is not sufficiently recovered as a result of the suppression technique. One technique to improve the picture quality, and in particular the sharpness of moving edges, is to apply image enhancement techniques on such moving edge regions. Examples of suitable image enhancement techniques may include, an unsharp masking (USM) or a Luminance Transient Improvement (LTI). The LTI may first convolve the image with Laplacian filters and then based on the magnitude and the sign of the Laplacian filtered values to push the current pixel values into local maximum or minimum values.

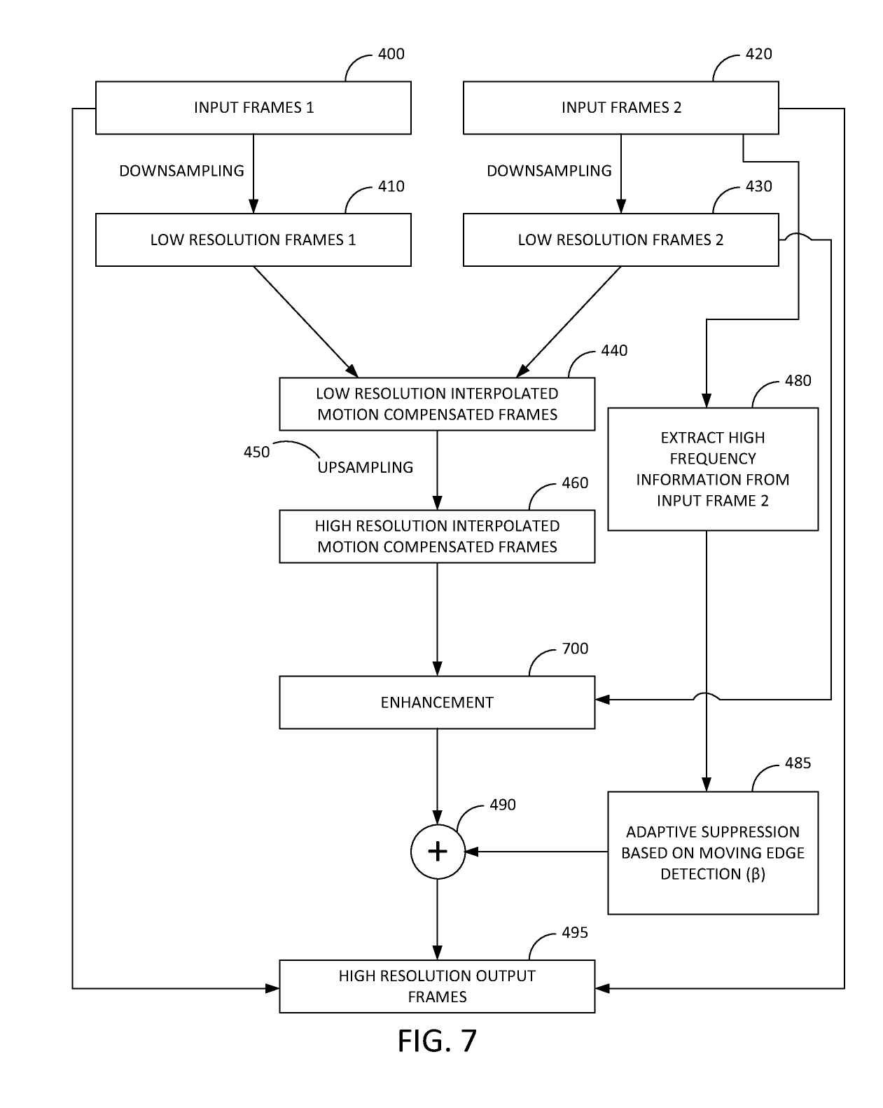

An exemplary embodiment illustrated in FIG. 7 includes a reduced resolution frame rate up conversion together with adaptively adding high frequency information from the adjacent input frame F₂ and meanwhile applying enhancement on the strong moving edges. In comparison to FIG. 4, an additional enhancement process 700 is applied to motion-compensated interpolated frames. The enhancement process may be applied before or after the upsampling process 450. The enhancement process may be focused on moving edges in order to enhance edge sharpness. The enhancement process 700 may be based on information extracted from one of the input frames, for example the location, sharpness or orientation of edges in a suitable input frame, or other edge characteristics.

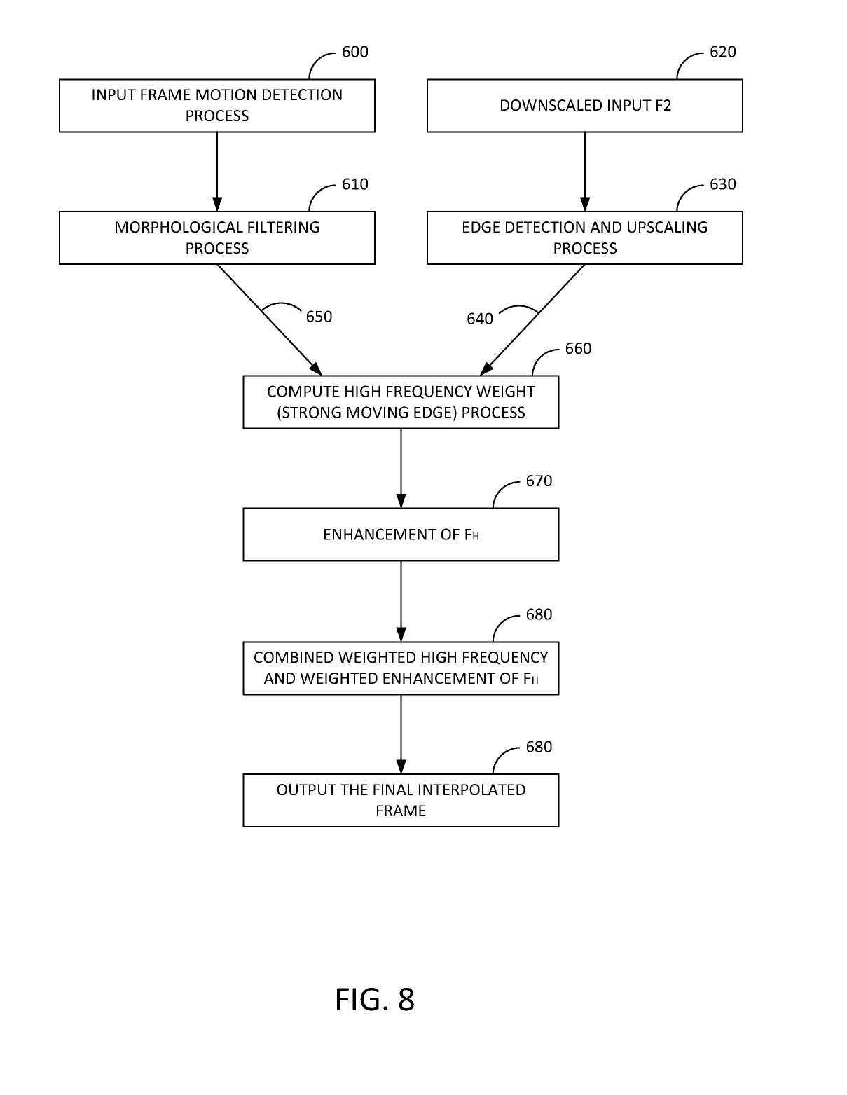

An exemplary embodiment illustrated in FIG. 8 shows a more detailed process of adaptively adding high frequency information from F₂ and meanwhile applying LTI enhancement on strong moving edges. In comparison to FIG. 6, instead of using the blurred interpolation image for the moving edge regions, LTI enhancement is applied on these regions and then final image is a blending with the LTI enhanced image and the image with full adding the high frequency information from F₂.

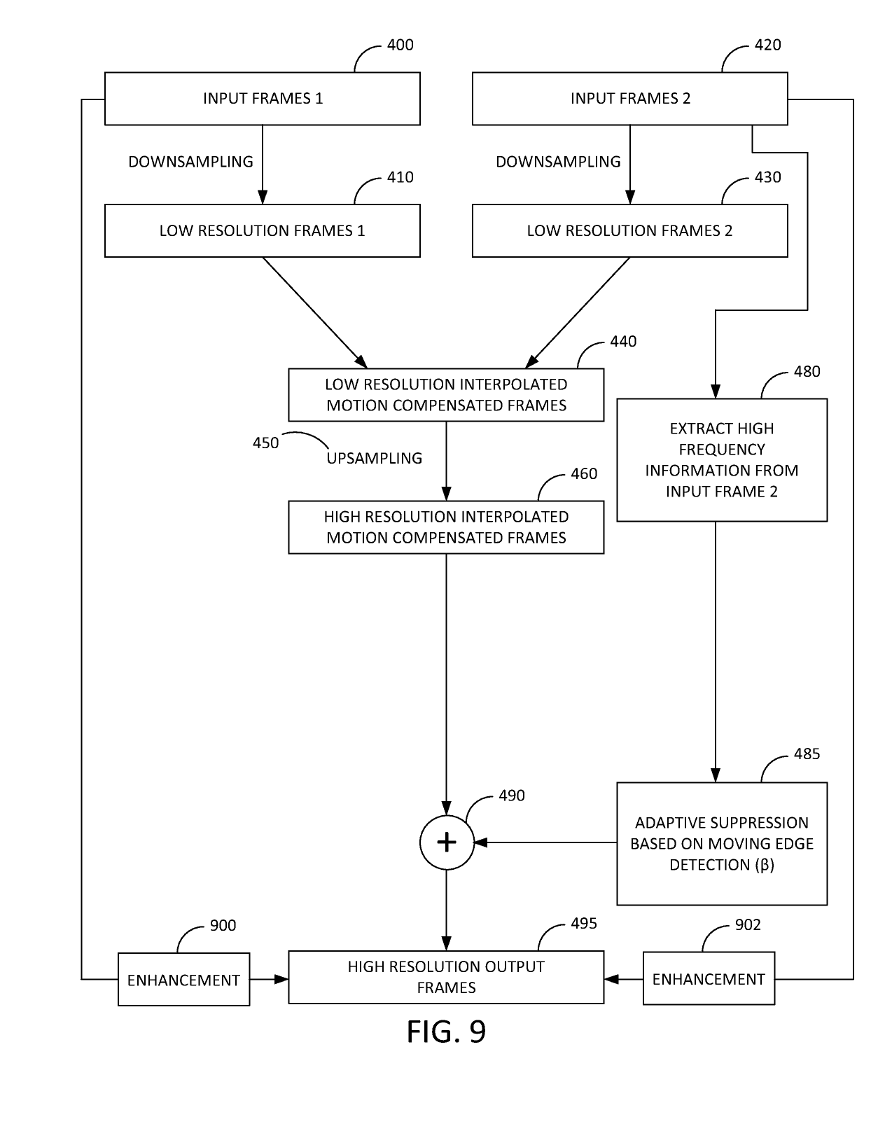

An exemplary embodiment illustrated in FIG. 9 includes a reduced resolution frame rate up conversion together with adaptively adding high frequency information from the adjacent input frame F₂ and meanwhile applying enhancement on the strong moving edges. One or more additional enhancement processes 900, 902 are applied to motion-compensated interpolated frames. The enhancement processes may be applied to the high resolution output frames 495. The enhancement processes may be focused on moving edges in order to enhance edge sharpness. The enhancement processes 900, 902 may be based on information extracted from the respective input frame, for example the location, sharpness or orientation of edges in a suitable input frame, or other edge characteristics.

The terms and expressions which have been employed in the foregoing specification are used in as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for frame rate conversion of a video comprising:
(a) receiving a series of frames having a first frame rate;
(b) downsampling said series of frames to a downsampled resolution;
(c) estimating motion vectors for said series of frames based upon said downsampled frames;
(d) determining motion compensated interpolated frames based upon said downsampled frames and said motion vectors based upon said downsampled frames;
(e) upsampling said motion compensated frames to provide output frames.

2. The method of claim 1 wherein said output frames have the same resolution as said series of frames.

3. The method of claim 1 further comprising extracting high frequency information from said series of frames and modifying said upsampled motion compensated frames to include said high frequency information.

4. The method of claim 3 wherein for a first one of said upsampled motion compensated frames is modified with high frequency information extracted from a sequentially adjacent one of said series of frames.

5. The method of claim 4 wherein said high frequency information is said extracted based upon downsampling and upsampling.

6. The method of claim 4 wherein said high frequency information is said extracted based upon a pass filter that attenuates lower frequencies with respect to higher frequencies.

7. The method of claim 3 further comprising suppression based upon moving edge detection.

8. The method of claim 7 wherein said suppression is applied to said extracted high frequency information.

9. The method of claim 8 further comprising suppression based upon moving edge detection applied to said motion compensated interpolated frames.

10. The method of claim 3 where said modifying is based upon a motion detection process.

11. The method of claim 3 wherein an enhancement process is applied to said upsampled motion compensated frames.

12. The method of claim 4 wherein said high frequency information is said extracted based upon a smoothing process.

13. The method of claim 7 where said suppression is based upon a motion detection process.

14. The method of claim 11 wherein said enhancement process is based upon one of said series of frames.

15. The method of claim 3 wherein an enhancement process is applied to one of said series of frames.
